(19) United States
(12) Patent Application Publication
(10) Pub. No.: US 2008/0313664 A1
(43) Pub. Date: Dec. 18, 2008

(54) Method to record, save, and send otherwise non-recordable and copyrighted material

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/818,095

(22) Filed: Jun. 13, 2007

(51) Int. Cl. H04N 7/16

(52) U.S. Cl. 725/1

(57) ABSTRACT

An apparatus in one example has: at least one media source operatively coupled to a controller, the controller selecting at least one media event from the at least one media source; the controller operatively coupled to a telecommunications system having at least one application server; a storage associated with the application server, the at least one media event saved to at least one media event file, an origin of a file content of the at least one media event file, and at least one destination associated with the at least one media event stored on the storage; at least one charge for a sending of the copy of the at least one media event file to the at least one destination; and a royalty fee based on the origin of the at least one media event file.

### TECHNICAL FIELD

The invention relates generally to telecommunication networks, and more particularly to a telecommunication network that provides a system for legally sharing copyrighted media content at any time in any place, such that appropriate royalty fees are paid to the content owners.

### BACKGROUND

In today's media centric world, there is an increasing need to be able to record, save, and send media to friends, family, and business associates. So for example, one might be watching a TV show and want to record an interesting or funny clip to send to a friend. Also, one might see a TV advertisement for a product that might be appropriate for a family member, so one could record the advertisement and send it to a relative in Florida, for example. Likewise, in business, one might hear a news story about a business competitor on the radio and want to record that audio segment and send it to a business associate to start a discussion. In each of these instances, the information to be recorded is often copyrighted.

Copyright infringement is the unauthorized use of material which is covered by copyright law, in a manner that violates one of the original copyright owner's exclusive rights, such as the right to reproduce or perform the copyrighted work.

Uploading or downloading works protected by copyright without the authority of the copyright owner is an infringement of the copyright owner's exclusive rights of reproduction and/or distribution. Anyone found to have infringed a copyrighted work may be liable for statutory damages up to $30,000 for each work infringed and, if willful infringement is proven by the copyright owner, that amount may be increased up to $150,000 for each work infringed. In addition, an infringer of a work may also be liable for the attorney's fees incurred by the copyright owner to enforce his or her rights.

Whether or not a particular work is being made available under the authority of the copyright owner is a question of fact. But since any original work of authorship fixed in a tangible medium (including a computer file) is protected by federal copyright law upon creation, in the absence of clear information to the contrary, most works may be assumed to be protected by federal copyright law.

Since the files distributed over peer-to-peer networks are primarily copyrighted works, there is a risk of liability for downloading material from these networks. To avoid these risks, there are currently many “authorized” services on the Internet that allow consumers to purchase copyrighted works online, whether music, ebooks, or motion pictures. By purchasing works through authorized services, consumers can avoid the risks of infringement liability and can limit their exposure to other potential risks, e.g., viruses, unexpected material, or spyware. However, for an individual it is too time consuming and expensive to purchase copyrighted works this way.

Thus, there is a need for an improved method of sharing copyrighted media content.

### SUMMARY

One implementation encompasses an apparatus. This embodiment of the apparatus may comprise: at least one media source operatively coupled to a controller, the controller selecting at least one media event from the at least one media source; the controller operatively coupled to a telecommunications system having at least one application server; a storage associated with the application server, the at least one media event saved to at least one media event file, an origin of a file content of the at least one media event file, and at least one destination associated with the at least one media event stored on the storage; at least one charge for a sending of the copy of the at least one media event file to the at least one destination; and a royalty fee based on the origin of the at least one media event file.

One implementation encompasses a method. This embodiment of the method may comprise: selecting at least one media event; saving the at least one media event to at least one media event file; entering at least one destination for the at least one media event file; uploading the at least one media event file and the at least one destination to an application server; determining an origin of a file content of the at least one media event file; storing the at least one media event file, the origin of the file content of the at least one media event file and the at least one destination at the application server; sending a copy of the at least one media event file to the at least one destination; recording at least one charge at the application server for the sending of the copy of the at least one media event file to the at least one destination; billing the at least one charge to a respective user; recording a royalty fee based on the origin of the at least one media event file; paying the royalty fee to an origin of a content of the at least one media event of the at least one media event file; and storing the at least one media event file at the application server until at least one of deleted by a user, and a file expiration time/date.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 is a representation of one implementation of an apparatus that provides for a system for legally sharing copyrighted media content;

FIG. 2 depicts a more detailed embodiment of a system for legally sharing copyrighted media content; and

FIG. 3 is a representation of one exemplary flow diagram for a system for legally sharing copyrighted media content.

### DETAILED DESCRIPTION

Embodiments according to the present method and apparatus provide a means for legally sharing otherwise copyrighted media content with other people at any time in any place, such that appropriate royalty fees are paid to the content owners.

Embodiments according to the present method and apparatus allow a person with a digital video recorder (DVR)to record television program segments, commercial segments, snips from a video movie, songs from a CD, or audio segments from a digital radio and to store those on a media server, such as an application server in a telecommunications system, for the purpose of either viewing them again later or sending them to another person or persons.

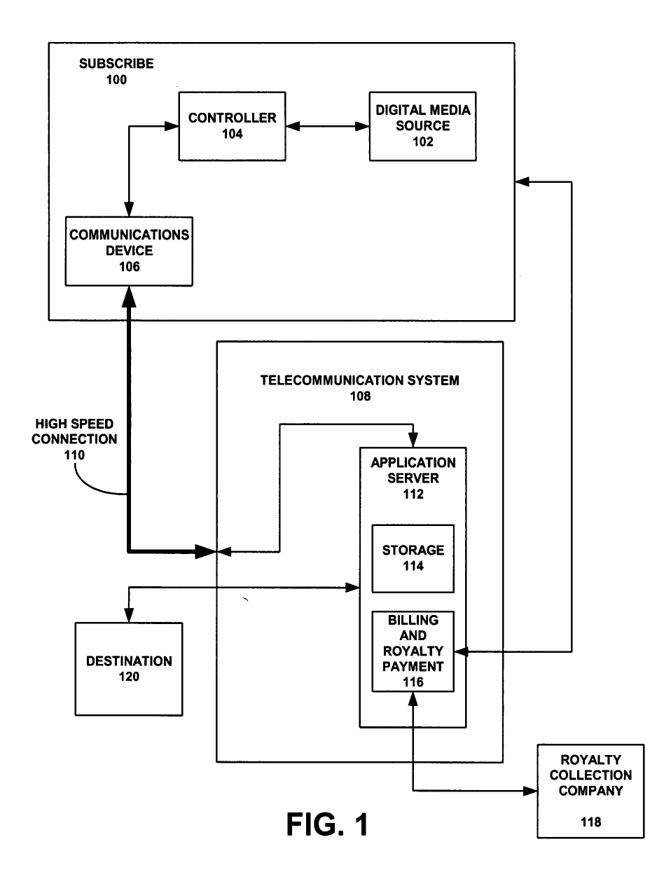

FIG. 1 is a representation of one implementation of an apparatus that provides for a system for legally sharing copyrighted media content.

At a subscriber location 100 at least one media source 102 may be operatively coupled to a controller 104. Via the controller 104 at least one media event may be selected from the at least one media source 102. The controller 104 may also determine at least one destination 120 for the sending of the at least one media event. The controller 104 may be operatively coupled to a telecommunications system 108 by a communications device 106. For example, the connection may be a high speed connection 110.

The telecommunication system 108 may have at least one application server 112 that has a storage 114. The at least one media event may be saved to at least one media event file. The at least one media event file, an origin of a file content of the at least one media event file, and at least one destination 120 associated with the at least one media event may be stored on the storage 114. The application server 112, in for example a billing and royalty payment module 116, may determine at least one charge for a sending of the copy of the at least one media event file to the at least one destination 120, and a royalty fee based on the origin of the at least one media event file. The at least one charge may be billed to a respective subscriber 100, and the royalty fee may be paid to an origin, such as royalty collection company 118, of a content of the at least one media event of the at least one media event file.

The present system and method may be used with any type of telecommunication network (wired and wireless, for example).

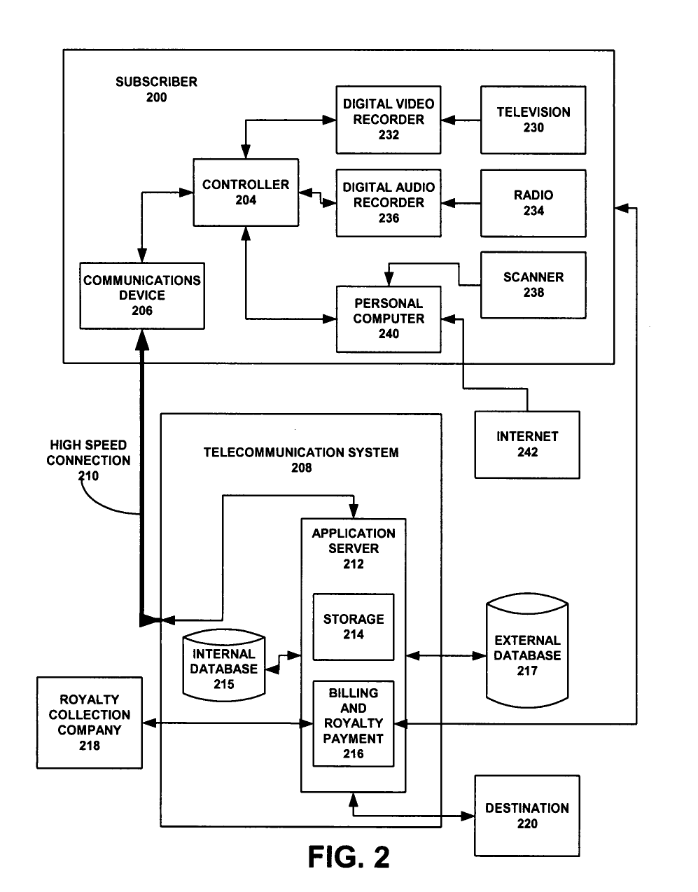

FIG. 2 depicts a more detailed embodiment of a system for legally sharing copyrighted media content.

At a subscriber location 200 a television 230 may be operatively coupled to a digital video recorder 232, a radio 234 may be operatively coupled to a digital audio recorder 236, and a scanner 238 may be operatively coupled to a personal computer 240. The personal computer 240 may also be operatively coupled to other sources of media content, such as the Internet 242. Each of these sources and recorders may be operatively coupled to a controller 204. Via the controller 204 at least one media event may be selected. The controller 204 may also determine at least one destination 220 for the sending of the at least one media event. The controller 204 may be operatively coupled to a telecommunications system 208 by a communications device 206. For example, the connection may be a high speed connection 210.

The telecommunication system 208 may have at least one application server 212 that has a storage 214. In addition to the storage 214 the application server 212 may be operatively coupled to an internal database 215 and/or an external database 217. The at least one media event may be saved to at least one media event file. The at least one media event file, an origin of a file content of the at least one media event file, and at least one destination 220 associated with the at least one media event may be stored on the storage 214, the internal database 215 and/or the external database 217. The application server 212, in for example a billing and royalty payment module 216, may determine at least one charge for a sending of the copy of the at least one media event file to the at least one destination 220, and a royalty fee based on the origin of the at least one media event file. The at least one charge may be billed to a respective subscriber 200, and the royalty fee may be paid to an origin, such as royalty collection company 218, of a content of the at least one media event of the at least one media event file.

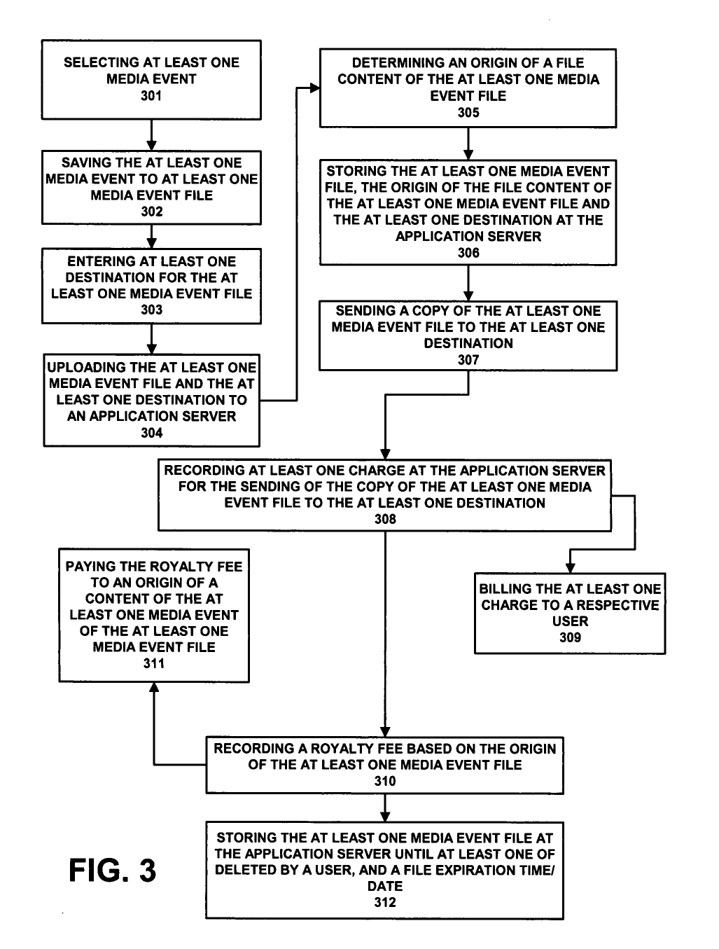

FIG. 3 is a representation of one exemplary flow diagram for a system for legally sharing copyrighted media content. The method may have the steps of: selecting at least one media event (301); saving the at least one media event to at least one media event file (302); entering at least one destination for the at least one media event file (303); uploading the at least one media event file and the at least one destination to an application server (304); determining an origin of a file content of the at least one media event file (305); storing the at least one media event file, the origin of the file content of the at least one media event file and the at least one destination at the application server (306); sending a copy of the at least one media event file to the at least one destination (307); recording at least one charge at the application server for the sending of the copy of the at least one media event file to the at least one destination (308); billing the at least one charge to a respective user (309); recording a royalty fee based on the origin of the at least one media event file (310); paying the royalty fee to an origin of a content of the at least one media event of the at least one media event file (311); and storing the at least one media event file at the application server until at least one of deleted by a user, and a file expiration time/date (312).

The following is an example using a television commercial.

1. A user sees a television commercial for a mobility scooter that will be covered by an insurance provider and/or a Medicare provider. The user desires to record this commercial and send it to a disabled parent who lives in Florida. The user may then press a “record last commercial” button on the television controller.

2. The last commercial is recorded and saved to a file on a digital video recorder (DVR).

3. The user may then press a “Send” button on the controller, and may enter an email, phone number, or IP address of the person or persons to whom the user desires to send this information.

4. The file may then be uploaded to an application server from the DVR, along with a destination(s) where the file is to be sent. 5. The application server stores the file along with an indication of where the file content originated from (i.e. TV network, radio, Video, etc.)

6. The application server sends a copy of the file to the indicated destination(s), the destination(s) being, for example, an email address, a mobile phone number, an Internet destination, etc.

7. The application server records a charge to an account of the user based on, for example, the file size and number of destinations to which the file is to be sent.

8. The application server records a royalty fee to be paid to the respective television station, radio station, recording artist, or movie house based on where the recorded file's content originated from.

9. The royalty fee may be itemized, for example, on a monthly television subscription service of the user or billed along with other recordings made by the application service provider.

10. The file may remain on the application server until deleted by user, or until a file expiration date.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus may comprise the recordable data storage medium (subscriber database). The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method, comprising:
selecting at least one media event;
saving the at least one media event to at least one media event file;
entering at least one destination for the at least one media event file;
uploading the at least one media event file and the at least one destination to an application server;
determining an origin of a file content of the at least one media event file;
storing the at least one media event file, the origin of the file content of the at least one media event file and the at least one destination at the application server;
sending a copy of the at least one media event file to the at least one destination;
recording at least one charge at the application server for the sending of the copy of the at least one media event file to the at least one destination; and
recording a royalty fee based on the origin of the at least one media event file.

2. The method according to claim 1, wherein the media event is a television program segment, and wherein the at least one media event is selected by activating a “record last commercial” button on a television controller.

3. The method according to claim 2, wherein the at least one media event file is saved on a digital video recorder (DVR).

4. The method according to claim 3, wherein the at least one destination for the at least one media event file is entered by activating a “Send” button on the television controller, and wherein the destination is at least one of an email address, a telephone number, or an IP address.

5. The method according to claim 1, wherein the application server records at least one charge to a predetermined account based on at least one of a file size of the at least one media event file and a number of destinations to which the at least one media event file is to be sent.

6. The method according to claim 1, wherein the application server records a royalty fee to be paid to a respective television station, radio station, recording artist, or movie house based on where the recorded file's content originated from.

7. The method according to claim 6, wherein the royalty fee is itemized on a periodic television subscription service.

8. The method according to claim 6, wherein the royalty fee is billed along with other recordings associated with other media event files stored at the application service.

9. The method according to claim 1, wherein the at least one media event file is stored at the application server until at least one of deleted by a user, and a file expiration time/date.

10. The method according to claim 1, wherein the at least one charge is billed to a respective user, and wherein the royalty fee is paid to an origin of a content of the at least one media event of the at least one media event file.

11. An apparatus, comprising:
at least one media source operatively coupled to a controller, the controller selecting at least one media event from the at least one media source;
the controller operatively coupled to a telecommunications system having at least one application server;
a storage associated with the application server, the at least one media event saved to at least one media event file, an origin of a file content of the at least one media event file, and at least one destination associated with the at least one media event stored on the storage;
at least one charge for a sending of the copy of the at least one media event file to the at least one destination; and
a royalty fee based on the origin of the at least one media event file.

12. The method according to claim 11, wherein the media event is a television program segment, and wherein the at least one media event is selected by activating a “record last commercial” button on a television controller.

13. The method according to claim 12, wherein the at least one media event file is saved on a digital video recorder (DVR).

14. The method according to claim 13, wherein the at least one destination for the at least one media event file is entered by activating a “Send” button on the television controller, and wherein the destination is at least one of an email address, a telephone number, or an IP address.

15. The method according to claim 11, wherein the application server records at least one charge to a predetermined account based on at least one of a file size of the at least one media event file and a number of destinations to which the at least one media event file is to be sent.

16. The method according to claim 11, wherein the application server records a royalty fee to be paid to a respective television station, radio station, recording artist, or movie house based on where the recorded file's content originated from.

17. The method according to claim 16, wherein the royalty fee is itemized on a periodic television subscription service.

18. The method according to claim 16, wherein the royalty fee is billed along with other recordings associated with other media event files stored at the application service.

19. The method according to claim 11, wherein the at least one media event file is stored at the application server until at least one of deleted by a user, and a file expiration time/date.

20. The method according to claim 11, wherein the at least one charge is billed to a respective user, and wherein the royalty fee is paid to an origin of a content of the at least one media event of the at least one media event file.
